(19) United States
(12) Patent Application Publication
(10) Pub. No.: US 2018/0123737 A1
(43) Pub. Date: May 3, 2018

(54) MULTI-SEGMENT DATA UNITS

(71) Applicant: QUALCOMM Incorporated, San Diego, CA (US)

(72) Inventors: Sameer Vermani, San Diego, CA (US); Bin Tian, San Diego, CA (US); Lochan Verma, San Diego, CA (US)

(21) Appl. No.: 15/796,316

(22) Filed: Oct. 27, 2017

Related U.S. Application Data
(60) Provisional application No. 62/416,050, filed on Nov. 1, 2016.

(51) Int. Cl. H04L 1/00; H04L 29/08; H04L 12/861

(52) U.S. Cl. CPC H04L 1/0079; H04L 69/161; H04L 49/9057; H04L 69/324

(57) ABSTRACT

Various aspects of the disclosure relate to communication using a data unit that includes a plurality of segments, where the different segments include information for different users. In some aspects, the data unit may be a Physical Layer Convergence Protocol (PLCP) Protocol Data Unit (PPDU) for Wi-Fi communication. In some aspects, the data unit may include an indication that all of the segments have the same length and/or resource allocation.

### CROSS-REFERENCE TO RELATED APPLICATION(S)

This application claims priority to and the benefit of U.S. Provisional Patent Application Ser. No. 62/416,050, filed on Nov. 1, 2016, the entire contents of which is incorporated herein by reference.

### INTRODUCTION

Various aspects described herein relate to wireless communication and, more particularly but not exclusively, to a data unit that includes a plurality of segments.

Some types of wireless communication devices employ multiple antennas to provide a higher level of performance as compared to devices that use a single antenna. For example, a wireless multiple-in-multiple-out (MIMO) system (e.g., a wireless local area network (WLAN) that supports IEEE 802.11ax) may use multiple transmit antennas to provide beamforming-based signal transmission. Typically, beamforming-based signals transmitted from different antennas are adjusted in phase (and optionally amplitude) such that the resulting signal power is focused toward a receiver device (e.g., an access terminal).

A wireless MIMO system may support communication for a single user at a time or for several users concurrently. Transmissions to a single user (e.g., a single receiver device) are commonly referred to as single-user MIMO (SU-MIMO), while concurrent transmissions to multiple users are commonly referred to as multi-user MIMO (MU-MIMO).

An access point (e.g., a base station) of a MIMO system employs multiple antennas for data transmission and reception, while each user employs one or more antennas. The access point communicates with the users via forward link channels and reverse link channels. In some aspects, a forward link (or downlink) channel refers to a communication channel from a transmit antenna of the access point to a receive antenna of a user, and a reverse link (or uplink) channel refers to a communication channel from a transmit antenna of a user to a receive antenna of the access point.

MIMO channels corresponding to transmissions from a set of transmit antennas to a receive antenna are referred to spatial streams since precoding (e.g., beamforming) is employed to direct the transmissions toward the receive antenna. Consequently, in some aspects each spatial stream corresponds to at least one dimension. A MIMO system thus provides improved performance (e.g., higher throughput and/or greater reliability) through the use of the additional dimensionalities provided by these spatial streams.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In some aspects, the disclosure provides an apparatus configured for communication. The apparatus includes: an interface configured to obtain data; and a processing system configured to generate a frame including the data, wherein the interface is configured to output the frame for transmission. In some aspects, the generation of the frame may involve: including the data in a plurality of segments of the frame; and including an indication in the frame, wherein the indication indicates whether at least one characteristic of the segments remains constant across the segments. In some implementations, separate interfaces could be used to obtain the data and output the frame.

In some aspects, the disclosure provides a method for communication including: obtaining data; generating a frame including the data; and outputting the frame for transmission. In some aspects, the generation of the frame may involve: including the data in a plurality of segments of the frame; and including an indication in the frame, wherein the indication indicates whether at least one characteristic of the segments remains constant across the segments.

In some aspects, the disclosure provides an apparatus configured for communication. The apparatus includes: means for obtaining data; means for generating a frame including the data; and means for outputting the frame for transmission. In some aspects, the generation of the frame may involve: including the data in a plurality of segments of the frame; and including an indication in the frame, wherein the indication indicates whether at least one characteristic of the segments remains constant across the segments.

In some aspects, the disclosure provides a wireless node. The wireless node includes: a receiver configured to receive data; a processing system configured to generate a frame including the data; and a transmitter configured to transmit the frame. In some aspects, the generation of the frame may involve: including the data in a plurality of segments of the frame; and including an indication in the frame, wherein the indication indicates whether at least one characteristic of the segments remains constant across the segments.

In some aspects, the disclosure provides a computer-readable medium (e.g., a non-transitory computer-readable medium) storing computer-executable code, including code to: obtain data; generate a frame including the data; and output the frame for transmission. In some aspects, the generation of the frame may involve: including the data in a plurality of segments of the frame; and including an indication in the frame, wherein the indication indicates whether at least one characteristic of the segments remains constant across the segments.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

The accompanying drawings are presented to aid in the description of aspects of the disclosure and are provided solely for illustration of the aspects and not limitations thereof.

FIG. 1 illustrates an example of transmitting and receiving devices in accordance with some aspects of the disclosure.

FIG. 2 illustrates an example of a wireless communication system in which aspects of the present disclosure may be employed.

FIG. 3 illustrates an example of a frame for wireless communication in accordance with some aspects of the disclosure.

FIG. 4 illustrates an example of a multi-segment PPDU for 802.11ax communication in accordance with some aspects of the disclosure.

FIG. 5 illustrates an example of a multi-segment PPDU for 802.11ax communication in accordance with some aspects of the disclosure.

FIG. 6 illustrates an example of signaling for a multi-segment PPDU in accordance with some aspects of the disclosure.

FIG. 7 illustrates an example of a wireless communication system in which aspects of the present disclosure may be employed.

FIG. 8 is a functional block diagram of an example apparatus that may be employed within a wireless communication system in accordance with some aspects of the disclosure.

FIG. 9 is a functional block diagram of example components that may be utilized in the apparatus of FIG. 8 to transmit wireless communication.

FIG. 10 is a functional block diagram of example components that may be utilized in the apparatus of FIG. 8 to receive wireless communication.

FIG. 11 is a functional block diagram of an example apparatus in accordance with some aspects of the disclosure.

FIG. 12 is a flow diagram of an example process in accordance with some aspects of the disclosure.

FIG. 13 is a flow diagram of example operations for the process of FIG. 12 in accordance with some aspects of the disclosure.

FIG. 14 is a simplified block diagram of several sample aspects of an apparatus configured with functionality in accordance with some aspects of the disclosure.

FIG. 15 is a simplified block diagram of several sample aspects of a memory configured with code in accordance with some aspects of the disclosure.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim. As an example of the above, in some aspects, a method of communication includes obtaining data; generating a frame; and outputting the frame for transmission. The generation of the frame may involve including the data in a plurality of segments of the frame and including an indication in the frame, where the indication indicates whether at least one characteristic of the segments remains constant across the segments.

The disclosure relates in some aspects to communication using a data unit that includes a plurality of segments, where the different segments include information for different users. In some aspects, the data unit may be a frame. In some aspects, the data unit may be a Physical Layer Convergence Protocol (PLCP) Protocol Data Unit (PPDU) for Wi-Fi communication. In some aspects, the data unit includes an indication that all of the segments have the same length and/or resource allocation. For example, the lengths of the data segments may be equal. As another example, the resource allocations may be at a fixed occurrence frequency.

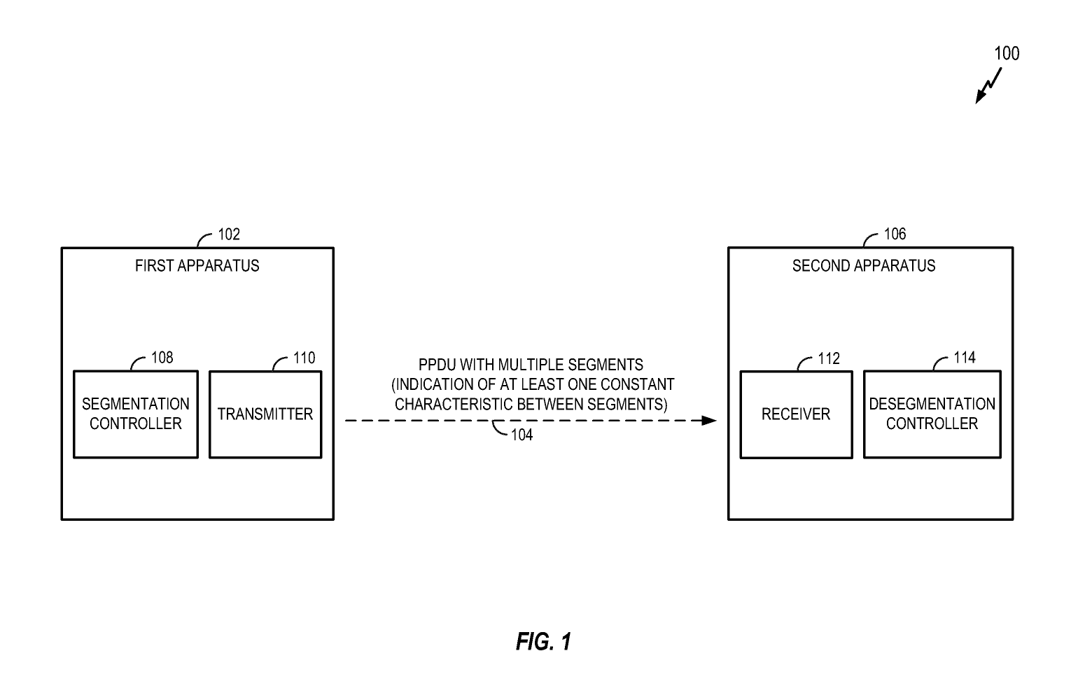

FIG. 1 illustrates a wireless communication system 100 where a first apparatus 102 sends a PPDU 104 with multiple segments to a second apparatus 106. To this end, a segmentation controller 108 of the first apparatus 102 segments information to be transmitted by a transmitter 110. For example, the segmentation controller 108 may include traffic for a first user and a second user in a first segment, traffic for a third user and a fourth user in a second segment, and so on.

In accordance with the teachings herein, in some scenarios, at least one characteristic of the segments may be the same across segments. As one example, the resource allocations for the segments may be the same (e.g., each of the segments is the same length). In this case, the PPDU 104 may include an indication of this constant characteristic (e.g., resource allocation) between segments. Thus, after the PPDU 104 is received by a receiver 112 of the second apparatus 106, a desegmentation controller 114 of the second apparatus 106 can determine how the PPDU 104 is segmented based on the indication.

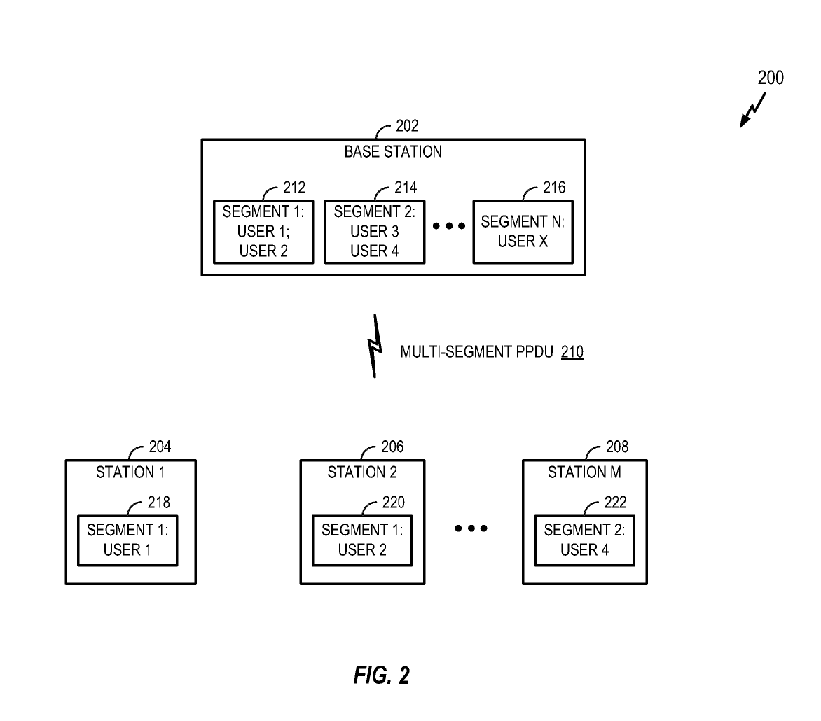

FIG. 2 illustrates an IEEE 802.11 network 200 where a base station 202 serves several users via multiple stations (represented by a first station 204, a second station 206, through an Mth station 208). The base station 202 transmits a multi-segment PPDU 210 that includes segments 1 to N, where each segment includes information for one or more users. For example, a first segment 212 includes information for users 1 and 2, a second segment 214 includes information for users 3 and 4, and an Nth segment 216 includes information for a user X.

Each station can thereby receive its corresponding segment and extract the corresponding user information from that segment. For example, the first station 204 may receive information 218 for user 1 from the first segment 212, the second station 206 may receive information 220 for user 2 from the first segment 212, and the Mth station 208 may receive information 222 for user 4 from the second segment 214.

Thus, in some aspects, the disclosure relates to a method of transmission to multiple users, with a subset of the users being served simultaneously in a first segment and another subset of the users being served in a second segment. A different number of subsets and/or a different number of segments may be used in various implementations. The subsets are allowed to have overlap. These techniques may be may be used in an 802.11 network, for example, future revisions of the 802.11ax standard or to be developed Wi-Fi standards.

### Example Frame Structure

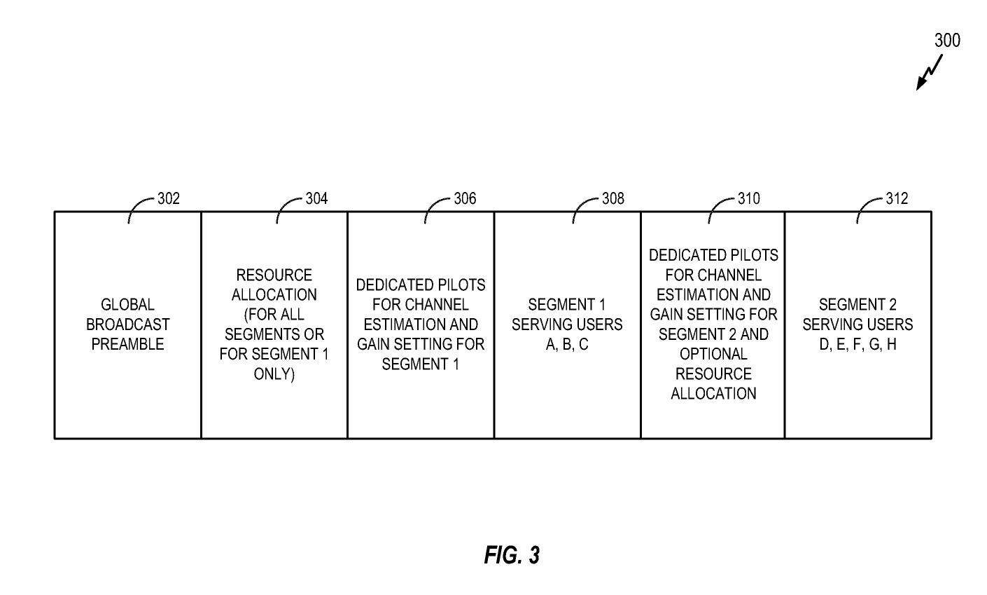

FIG. 3 illustrates an example of a frame 300 that includes multiple segments. The frame 300 includes a global broadcast preamble 302, a resource allocation 304 for all segments or only for segment 1, dedicated pilots for channel estimation and gain setting for segment 1 306, segment 1 (serving users A, B, and C) 308, dedicated pilots for channel estimation and gain setting for segment 2 (and resource allocation for segment 2 if the resource allocation 304 is only for the first segment) 310, and segment 2 (serving users D, E, F, G, and H) 312. The number of users shown in each segment are for illustration purposes only. Different numbers of users may be used in other implementations.

The disclosure relates in some aspect to the use of an indication (e.g., in the first resource allocation) to signal one or more of the following: 1) whether each PPDU segment has the same length; 2) the frequency of channel estimation/gain setting updates to handle mobility (e.g., before every segment); or 3) whether the resource allocation stays constant. In some aspects, if the resource allocation stays constant, then coding may be continuous across multiple segments.

In other words, the handling of mobility may be considered a special case of a multi-segment PPDU. In some aspects, this involves having constant length data segments, where channel estimation and/or gain setting updates occur before each segment. Restricting the resource allocation to be constant can be an additional, optional, restriction.

### Example Multi-Segment PPDUs

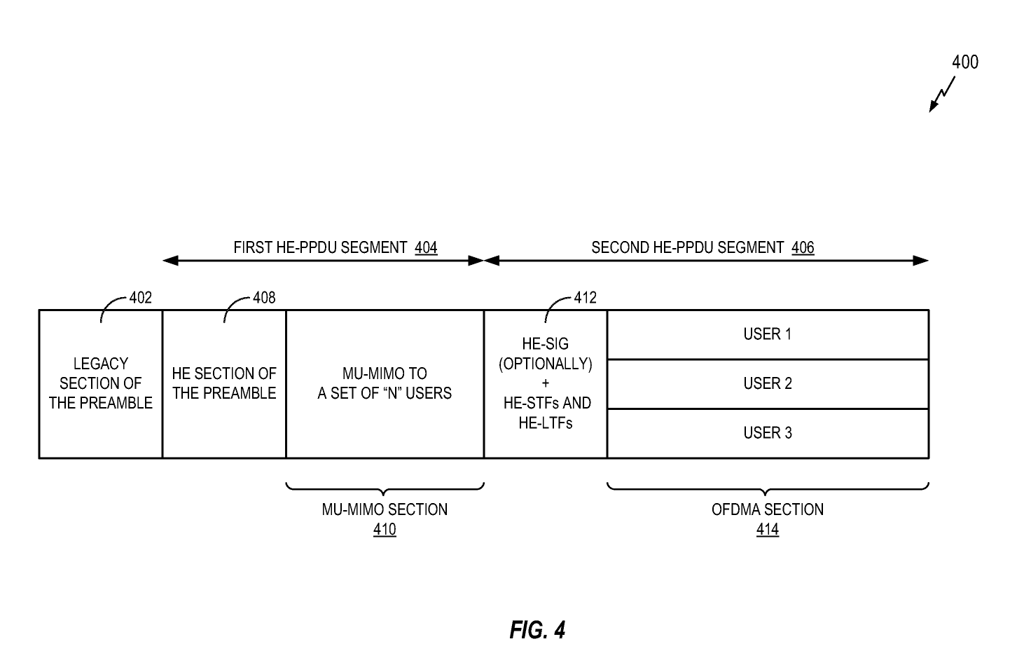

FIG. 4 illustrates an example of a multi-segment PPDU 400 (e.g., an aggregate PPDU) that may be applicable to IEEE 802.11ax or some other type of wireless communication. As indicated, different sets of users may be served in one PPDU. In addition, there may be multiple segments in one packet. FIG. 4 shows an example with a high efficiency PPDU (HE-PPDU). Other types of PPDUs may be used in other examples.

In this example, the PPDU 400 includes a legacy section of the preamble 402, a first HE-PPDU segment 404, and a second HE-PPDU segment 406. The first HE-PPDU segment 404 includes an HE section of the preamble 408 and a MU-MIMO section 410 (e.g., indicating MU-MIMO for a set of N users). The second HE-PPDU segment 406 includes an HE section 412 and an OFDMA section 414 (e.g., including data for user 1, user 2, and user 3). The HE section 412 includes HE short training fields (HE-STFs) and/or HE long training fields (HE-LTFs), and could, in some cases, include an HE signaling field (HE-SIG) for the corresponding PPDU.

In some aspects, the structure of FIG. 4 may be used to amortize legacy preamble and medium access overhead. Three example high level options will now be discussed. Other options could be used in other implementations.

In a first option (Option 1), the first HE segment (e.g., in an HE signaling field, HE-SIG) includes information about future HE-segments. For example, this HE segment (e.g., the HE section of the preamble 408 in FIG. 4) could indicate the length of the segments and/or the resource allocation of all the segments. Thus, in Option 1, additional HE-SIGs might not be used before any segments (e.g., the second HE-PPDU segment 406) that follow the first HE segment (e.g., the first HE-PPDU segment 404).

In a second option (Option 2), each HE-segment might only include information for that corresponding segment. For example, a given HE segment could indicate the length of the corresponding segment and/or the resource allocation of the corresponding segment. In Option 2, the HE-SIG may be included before every segment.

In a third option (Option 3), the first HE-SIG might only include information regarding which users need to monitor future SIGs. In this case, there may be a SIG before each segment which conveys the resource allocation for that segment.

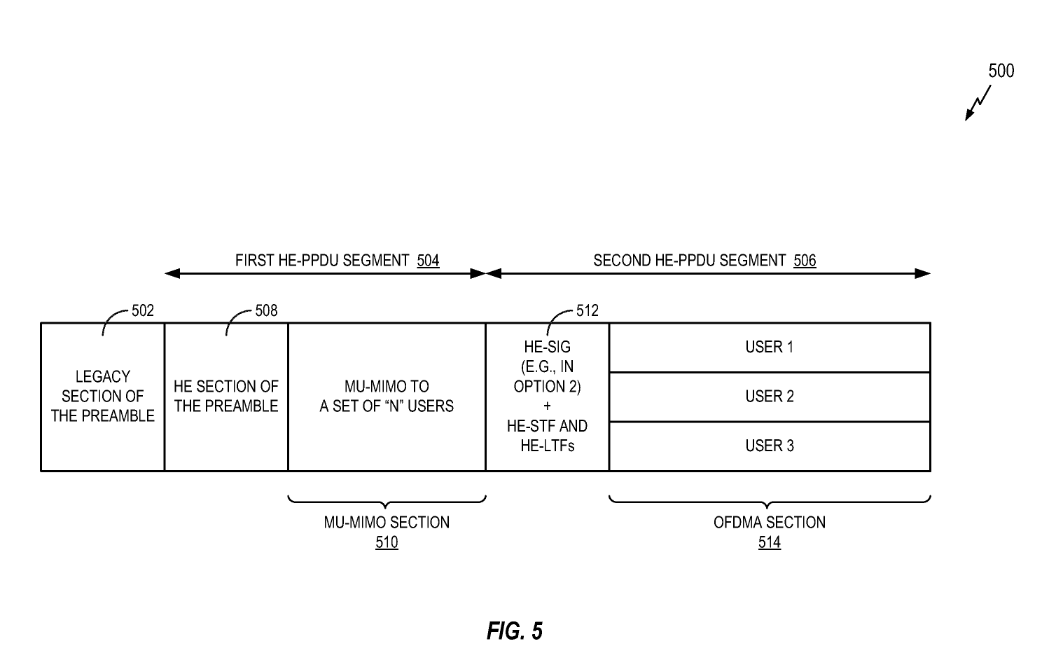

For example, FIG. 5 illustrates an example of a multi-segment PPDU 500 that includes an HE-SIG before each subsequent segment (only subsequent segment 2 is shown in this example). In this example, the PPDU 500 includes a legacy section of the preamble 502, a first high efficiency (HE-PPDU) segment 504, and a second HE-PPDU segment 506. The first HE-PPDU segment 504 includes an HE section of the preamble 508 and a MU-MIMO section 510 (e.g., indicating MU-MIMO for a set of N users). The second HE-PPDU segment 506 includes an HE section 512 and an OFDMA section 514 (e.g., including data for user 1, user 2, and user 3). The HE section 512 includes HE short training fields (HE-STFs) and/or HE long training fields (HE-LTFs), and, e.g., in Option 2, an HE-SIG field for the corresponding PPDU.

Option 1 may have, for example, the following advantages. Stations (STAs) that do not have data in the multi-segment PPDU can determine this at the start of the packet. This may improve the power consumption of the STAs since they may be able to stay in sleep mode longer (e.g., by going back to sleep immediately). In some aspects, it may be more efficient to have the STAs know upfront that they have data in the PPDU and in what section of the PPDU.

The use of Option 3 may also allow STAs that do not have data to go back to sleep immediately.

### Example Signaling

The HE-SIG-A of the 802.11ax standard contains a Doppler bit. A precise meaning has not been attributed to this bit. It may, in general, be used for mobility. For example, the bit being ON would turn ON mobility support in the packet.

The disclosure relates in some aspects to using the Doppler bit or some other bit (or bits) to support multi-segment PPDUs. Thus, mobility may be considered as a special case of a multi-segment PPDU. Mobility support can come from repeated channel estimation sections after short segments. In some aspects, the segments can have a constant length and the resource allocation does not need to change.

Five aspects regarding the use of such a bit (or bits) will be discussed in the context of Option 1. It should be appreciated that these or other aspects may be used with other options.

In a first aspect (Aspect 1), the HE-SIG-A Doppler bit may be defined as indicating a multi-segment PPDU. Doppler handling can be a special case of this aspect. For example, a multi-segment PPDU may have constant resource allocation and a consistent appearance frequency (e.g., how often they occur) of short training fields/long training fields (STFs/LTFs). In general, however, the segments of a multi-segment PPDU can have different lengths (e.g. for low-mobility scenarios). As used herein, a mobility scenario generally refers to a scenario where the STA and/or the base station is moving (e.g., and channel conditions are therefore changing relatively rapidly), where high mobility refers to the case where the movement is faster than a low mobility scenario. In some aspects, mobility may be characterized as high or low by comparing a characteristic of the mobility (e.g., the rate at which channel conditions are changing) with one or more thresholds. As one example, a rate above a particular threshold may indicate high mobility while a rate below that same threshold may indicate low mobility. As another example, there may be a high threshold (e.g., a rate above the high threshold may indicate high mobility) and a low threshold (e.g., a rate below the low threshold may indicate high mobility). Mobility may be characterized in other ways as well.

In a second aspect (Aspect 2) the HE-SIG-B common field may assume a different purpose (e.g., meaning of the bits) when the multi-segment bit (e.g., the Doppler bit) is ON. In an alternate implementation, the HE-SIG-B common field is not affected by the value of the multi-segment bit. In this latter case, the HE-SIG-B common field still conveys the resource unit (RU) allocation for the segment under question.

In a third aspect (Aspect 3), the HE-SIG-B will have multiple segments for each PPDU segment.

In a fourth aspect (Aspect 4), an additional HE-dedicated segment is added in each HE-SIG-B segment (e.g., at a fixed location, such as the first block in first content channel) whenever the multi-segment bit is ON. (When the multi-segment bit is OFF, this additional segment is not included.)

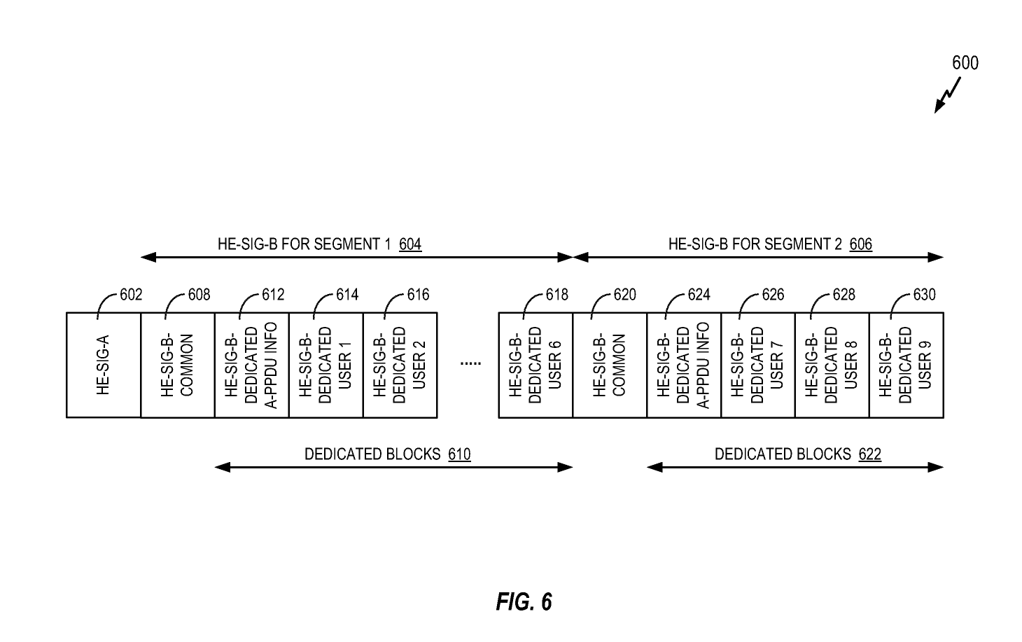

This dynamic segment could be referred to, for example, as a multi-segment PPDU (M-PPDU) information field (see FIG. 6 discussed below). This field could convey information such as the length of the SIG-B for this segment, the length of the payload for this segment, information about the number of SIG-B segments, whether there are more SIG-B segments, or any combination thereof. The last SIG-B segment's M-PPDU information dedicated block may include an indication that this block is the last block of SIG-B.

For example, FIG. 6 illustrates an example of a multi-segment PPDU 600 that includes HE-SIG fields for different segments (only segment 1 and segment 2 are shown in this example). The PPDU 600 includes an HE-SIG-A 602, an HE-SIG-B for segment 1 604, and an HE-SIG-B for segment 2 606. The HE-SIG-B for segment 1 604 includes an HE-SIG-B common field 608 and dedicated blocks 610. The dedicated blocks 610 include an HE-SIG-B dedicated Aggregate PPDU (A-PPDU) information field 612 and HE-SIG-B dedicated user fields (e.g., fields 614, 616, . . . , 618) for users 1-6. The HE-SIG-B for segment 2 606 includes an HE-SIG-B common field 620 and dedicated blocks 622. The dedicated blocks 622 include an HE-SIG-B dedicated A-PPDU information field 624 and HE-SIG-B dedicated user fields (e.g., fields 626, 628, and 630) for users 7-9.

The first SIG-B segment's A-PPDU information can also convey that this PPDU is a high mobility (high Doppler) PPDU. Thus, this information may convey that this PPDU is a constant resource allocation PPDU and/or constant midamble frequency PPDU. In this case, the resource allocation for multiple segments might not be needed (since the resource allocation is constant). A midamble may include, for example, training fields for channel estimation and/or gain setting updates.

In addition, in this scenario, the frequency of the midamble (e.g., channel estimation section and gain setting section) may be conveyed in the A-PPDU info. For example, midambles may be inserted more frequently for higher mobility scenarios. As used herein, a high mobility scenario relates to a case where channel conditions are changing more quickly (as compared to a low mobility scenario) due to movement of the transmitter and/or the receiver. In a high mobility scenario, the channel estimation and the gain setting may be updated more frequently to better account for potentially rapidly changing radio conditions.

Thus, in Aspect 4, the Doppler bit when turned ON could indicate that this PPDU is a multi-segment PPDU. In addition, information indicating that this is a high-mobility PPDU may be carried in the first resource allocation segment.

In a fifth aspect (Aspect 5), a coding difference may be indicated. If the resource allocation changes from one segment to next, forward error correction (FEC) coding may terminate at the segment boundary. If the resource allocation stays constant across segments, FEC coding may be across segments.

In some aspects, the length of the segments may be a function of the modulation and coding scheme (MCS) used and/or whether mobility is supported.

### Example Wireless Communication System

The teachings herein may be implemented using various wireless technologies and/or various spectra. Wireless network technologies may include various types of wireless local area networks (WLANs). A WLAN may be used to interconnect nearby devices together, employing widely used networking protocols. The various aspects described herein may apply to any communication standard, such as Wi-Fi or, more generally, any member of the IEEE 802.11 family of wireless protocols.

In some aspects, wireless signals may be transmitted according to an 802.11 protocol using orthogonal frequency-division multiplexing (OFDM), direct-sequence spread spectrum (DSSS) communication, a combination of OFDM and DSSS communication, or other schemes.

Certain of the devices described herein may further implement Multiple Input Multiple Output (MIMO) technology and be implemented as part of an 802.11 protocol. A MIMO system employs multiple (Nₜ) transmit antennas and multiple (Nᵣ) receive antennas for data transmission. A MIMO channel formed by the Nₜ transmit and Nᵣ receive antennas may be decomposed into Nₛ independent channels, which are also referred to as spatial channels or streams, where Nₛ≤min{Nₜ, Nᵣ}. Each of the Nₛ independent channels corresponds to a dimension. The MIMO system can provide improved performance (e.g., higher throughput and/or greater reliability) if the additional dimensionalities created by the multiple transmit and receive antennas are utilized.

In some implementations, a WLAN includes various devices that access the wireless network. For example, there may be two types of devices: access points (“APs”) and clients (also referred to as stations, or “STAs”). In general, an AP serves as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point (“AP”) may also comprise, be implemented as, or known as a Transmit Receive Point (TRP), a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

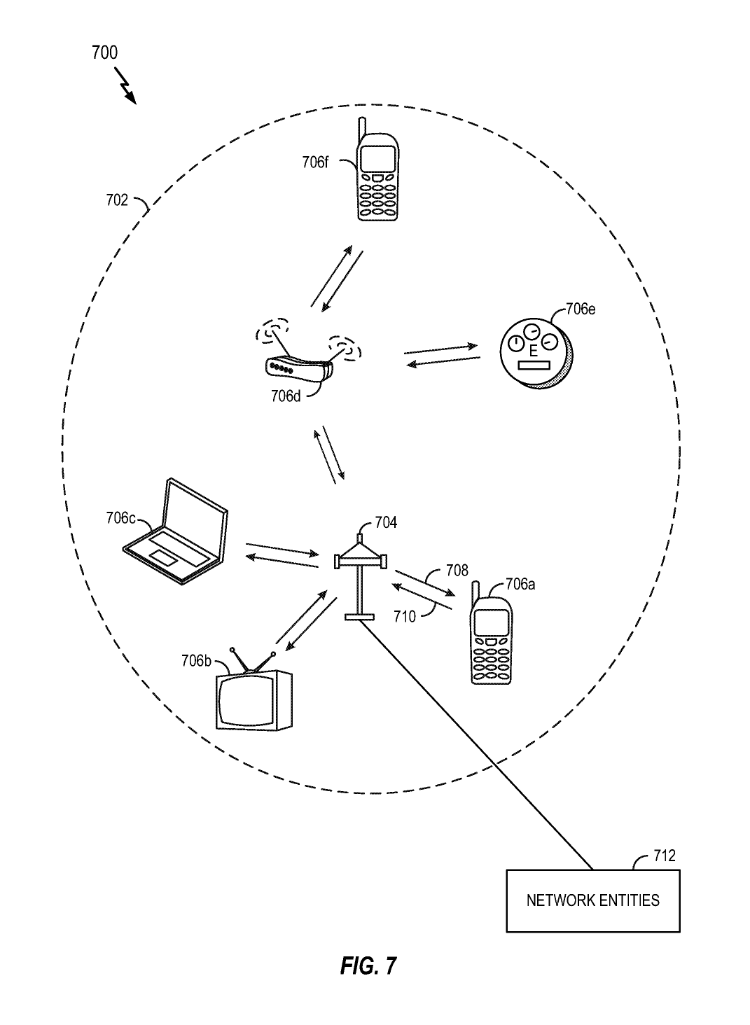

FIG. 7 illustrates an example of a wireless communication system 700 in which aspects of the present disclosure may be employed. The wireless communication system 700 may operate pursuant to a wireless standard, for example the 802.11 standard. The wireless communication system 700 may include an AP 704, which communicates with STAs 706a, 706b, 706c, 706d, 706e, and 706f (collectively STAs 706).

STAs 706e and 706f may have difficulty communicating with the AP 704 or may be out of range and unable to communicate with the AP 704. As such, another STA 706d may be configured as a relay device (e.g., a device comprising STA and AP functionality) that relays communication between the AP 704 and the STAs 706e and 706f.

A variety of processes and methods may be used for transmissions in the wireless communication system 700 between the AP 704 and the STAs 706. For example, signals may be sent and received between the AP 704 and the STAs 706 in accordance with OFDM/OFDMA techniques. If this is the case, the wireless communication system 700 may be referred to as an OFDM/OFDMA system. Alternatively, signals may be sent and received between the AP 704 and the STAs 706 in accordance with CDMA techniques. If this is the case, the wireless communication system 700 may be referred to as a CDMA system.

A communication link that facilitates transmission from the AP 704 to one or more of the STAs 706 may be referred to as a downlink (DL) 708, and a communication link that facilitates transmission from one or more of the STAs 706 to the AP 704 may be referred to as an uplink (UL) 710. Alternatively, a downlink 708 may be referred to as a forward link or a forward channel, and an uplink 710 may be referred to as a reverse link or a reverse channel.

The AP 704 may act as a base station and provide wireless communication coverage in a basic service area (BSA) 702. The AP 704 along with the STAs 706 associated with the AP 704 and that use the AP 704 for communication may be referred to as a basic service set (BSS).

Access points may thus be deployed in a communication network to provide access to one or more services (e.g., network connectivity) for one or more access terminals that may be installed within or that may roam throughout a coverage area of the network. For example, at various points in time an access terminal may connect to the AP 704 or to some other access point in the network (not shown).

Each of the access points may communicate with one or more network entities (represented, for convenience, by network entities 712 in FIG. 7), including each other, to facilitate wide area network connectivity. A network entity may take various forms such as, for example, one or more radio and/or core network entities. Thus, in various implementations the network entities 712 may represent functionality such as at least one of: network management (e.g., via an authentication, authorization, and accounting (AAA) server), session management, mobility management, gateway functions, interworking functions, database functionality, or some other suitable network functionality. Two or more of such network entities may be co-located and/or two or more of such network entities may be distributed throughout a network.

It should be noted that in some implementations the wireless communication system 700 might not have a central AP 704, but rather may function as a peer-to-peer network between the STAs 706. Accordingly, the functions of the AP 704 described herein may alternatively be performed by one or more of the STAs 706. Also, as mentioned above, a relay may incorporate at least some of the functionality of an AP and a STA.

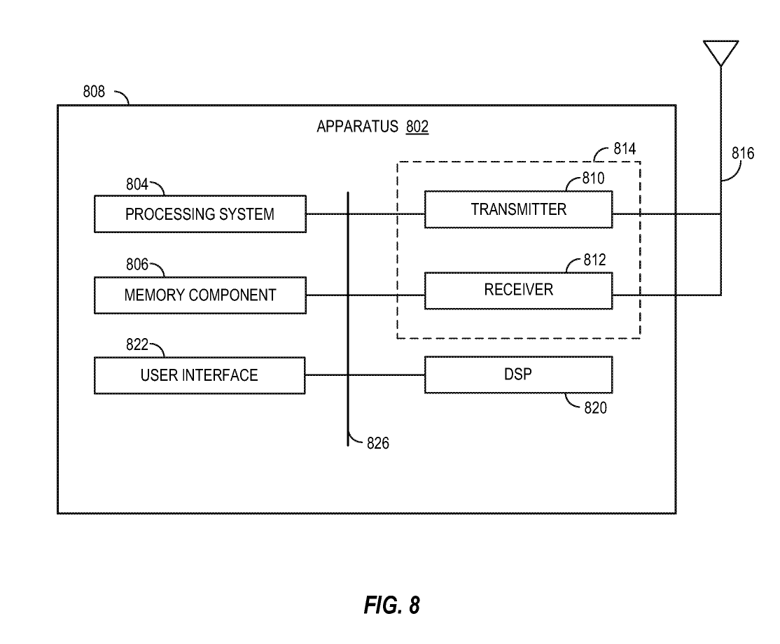

FIG. 8 illustrates various components that may be utilized in an apparatus 802 (e.g., a wireless device) that may be employed within the wireless communication system 700. The apparatus 802 is an example of a device that may be configured to implement the various methods described herein. For example, the apparatus 802 may comprise the AP 704, a relay (e.g., the STA 706d), or one of the STAs 706 of FIG. 7.

The apparatus 802 may include a processing system 804 that controls operation of the apparatus 802. The processing system 804 may also be referred to as a central processing unit (CPU). A memory component 806 (e.g., including a memory device), which may include both read-only memory (ROM) and random access memory (RAM), provides instructions and data to the processing system 804. A portion of the memory component 806 may also include non-volatile random access memory (NVRAM). The processing system 804 typically performs logical and arithmetic operations based on program instructions stored within the memory component 806. The instructions in the memory component 806 may be executable to implement the methods described herein.

When the apparatus 802 is implemented or used as a transmitting node, the processing system 804 may be configured to select one of a plurality of media access control (MAC) header types, and to generate a packet having that MAC header type. For example, the processing system 804 may be configured to generate a packet comprising a MAC header and a payload and to determine what type of MAC header to use.

When the apparatus 802 is implemented or used as a receiving node, the processing system 804 may be configured to process packets of a plurality of different MAC header types. For example, the processing system 804 may be configured to determine the type of MAC header used in a packet and process the packet and/or fields of the MAC header.

The processing system 804 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The apparatus 802 may also include a housing 808 that may include a transmitter 810 and a receiver 812 to allow transmission and reception of data between the apparatus 802 and a remote location. The transmitter 810 and receiver 812 may be combined into single communication device (e.g., a transceiver 814). An antenna 816 may be attached to the housing 808 and electrically coupled to the transceiver 814. The apparatus 802 may also include (not shown) multiple transmitters, multiple receivers, multiple transceivers, and/or multiple antennas. A transmitter 810 and a receiver 812 may comprise an integrated device (e.g., embodied as a transmitter circuit and a receiver circuit of a single communication device) in some implementations, may comprise a separate transmitter device and a separate receiver device in some implementations, or may be embodied in other ways in other implementations.

The transmitter 810 may be configured to wirelessly transmit packets having different MAC header types. For example, the transmitter 810 may be configured to transmit packets with different types of headers generated by the processing system 804, discussed above.

The receiver 812 may be configured to wirelessly receive packets having different MAC header type. In some aspects, the receiver 812 is configured to detect a type of a MAC header used and process the packet accordingly.

The receiver 812 may be used to detect and quantify the level of signals received by the transceiver 814. The receiver 812 may detect such signals as total energy, energy per subcarrier per symbol, power spectral density and other signals. The apparatus 802 may also include a digital signal processor (DSP) 820 for use in processing signals. The DSP 820 may be configured to generate a data unit for transmission. In some aspects, the data unit may comprise a physical layer data unit (PPDU). In some aspects, the PPDU is referred to as a packet.

The apparatus 802 may further comprise a user interface 822 in some aspects. The user interface 822 may comprise a keypad, a microphone, a speaker, and/or a display. The user interface 822 may include any element or component that conveys information to a user of the apparatus 802 and/or receives input from the user.

The various components of the apparatus 802 may be coupled together by a bus system 826. The bus system 826 may include a data bus, for example, as well as a power bus, a control signal bus, and a status signal bus in addition to the data bus. Those of skill in the art will appreciate the components of the apparatus 802 may be coupled together or accept or provide inputs to each other using some other mechanism.

Although a number of separate components are illustrated in FIG. 8, one or more of the components may be combined or commonly implemented. For example, the processing system 804 may be used to implement not only the functionality described above with respect to the processing system 804, but also to implement the functionality described above with respect to the transceiver 814 and/or the DSP 820. Further, each of the components illustrated in FIG. 8 may be implemented using a plurality of separate elements. Furthermore, the processing system 804 may be used to implement any of the components, modules, circuits, or the like described below, or each may be implemented using a plurality of separate elements.

For ease of reference, when the apparatus 802 is configured as a transmitting node, it is hereinafter referred to as an apparatus 802t. Similarly, when the apparatus 802 is configured as a receiving node, it is hereinafter referred to as an apparatus 802r. A device in the wireless communication system 700 may implement only functionality of a transmitting node, only functionality of a receiving node, or functionality of both a transmitting node and a receive node.

As discussed above, the apparatus 802 may comprise an AP 704 or a STA 706, and may be used to transmit and/or receive communication having a plurality of MAC header types.

The components of FIG. 8 may be implemented in various ways. In some implementations, the components of FIG. 8 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks of FIG. 8 may be implemented by processor and memory component(s) of the apparatus (e.g., by execution of appropriate code and/or by appropriate configuration of processor components). It should be appreciated that these components may be implemented in different types of apparatuses in different implementations (e.g., in an ASIC, in a system-on-a-chip (SoC), etc.).

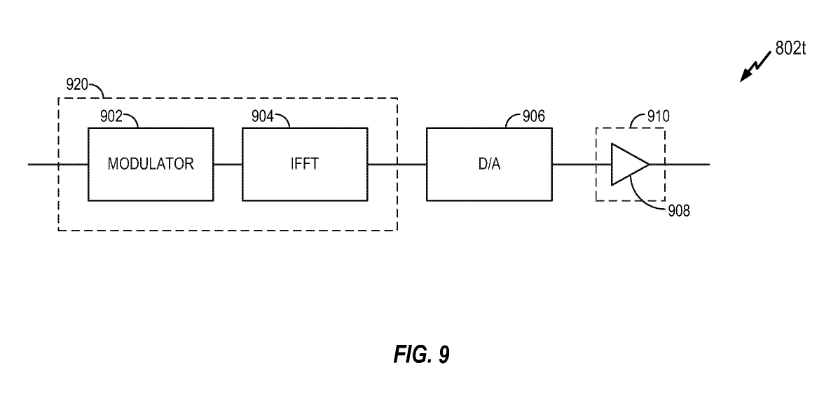

As discussed above, the apparatus 802 may comprise an AP 704 or a STA 706, a relay, or some other type of apparatus, and may be used to transmit and/or receive communication. FIG. 9 illustrates various components that may be utilized in the apparatus 802t to transmit wireless communication. The components illustrated in FIG. 9 may be used, for example, to transmit OFDM communication. In some aspects, the components illustrated in FIG. 9 are used to generate and transmit packets to be sent over a bandwidth of less than or equal to 1 MHz.

The apparatus 802t of FIG. 9 may comprise a modulator 902 configured to modulate bits for transmission. For example, the modulator 902 may determine a plurality of symbols from bits received from the processing system 804 (FIG. 8) or the user interface 822 (FIG. 8), for example by mapping bits to a plurality of symbols according to a constellation. The bits may correspond to user data or to control information. In some aspects, the bits are received in codewords. In one aspect, the modulator 902 may comprise a QAM (quadrature amplitude modulation) modulator, for example, a 16-QAM modulator or a 64-QAM modulator. In other aspects, the modulator 902 may comprise a binary phase-shift keying (BPSK) modulator, a quadrature phase-shift keying (QPSK) modulator, or an 8-PSK modulator.

The apparatus 802t may further comprise a transform module 904 configured to convert symbols or otherwise modulated bits from the modulator 902 into a time domain. In FIG. 9, the transform module 904 is illustrated as being implemented by an inverse fast Fourier transform (IFFT) module. In some implementations, there may be multiple transform modules (not shown) that transform units of data of different sizes. In some implementations, the transform module 904 may be itself configured to transform units of data of different sizes. For example, the transform module 904 may be configured with a plurality of modes, and may use a different number of points to convert the symbols in each mode. For example, the IFFT may have a mode where 32 points are used to convert symbols being transmitted over 32 tones (i.e., subcarriers) into a time domain, and a mode where 64 points are used to convert symbols being transmitted over 64 tones into a time domain. The number of points used by the transform module 904 may be referred to as the size of the transform module 904.

In FIG. 9, the modulator 902 and the transform module 904 are illustrated as being implemented in the DSP 920. In some aspects, however, one or both of the modulator 902 and the transform module 904 are implemented in the processing system 804 or in another element of the apparatus 802t (e.g., see description above with reference to FIG. 8).

As discussed above, the DSP 920 may be configured to generate a data unit for transmission. In some aspects, the modulator 902 and the transform module 904 may be configured to generate a data unit comprising a plurality of fields including control information and a plurality of data symbols.

Returning to the description of FIG. 9, the apparatus 802t may further comprise a digital to analog converter 906 configured to convert the output of the transform module into an analog signal. For example, the time-domain output of the transform module 904 may be converted to a baseband OFDM signal by the digital to analog converter 906. The digital to analog converter 906 may be implemented in the processing system 804 or in another element of the apparatus 802 of FIG. 8. In some aspects, the digital to analog converter 906 is implemented in the transceiver 814 (FIG. 8) or in a data transmit processor.

The analog signal may be wirelessly transmitted by the transmitter 910. The analog signal may be further processed before being transmitted by the transmitter 910, for example by being filtered or by being upconverted to an intermediate or carrier frequency. In the aspect illustrated in FIG. 9, the transmitter 910 includes a transmit amplifier 908. Prior to being transmitted, the analog signal may be amplified by the transmit amplifier 908. In some aspects, the amplifier 908 comprises a low noise amplifier (LNA).

The transmitter 910 is configured to transmit one or more packets or data units in a wireless signal based on the analog signal. The data units may be generated using the processing system 804 (FIG. 8) and/or the DSP 920, for example using the modulator 902 and the transform module 904 as discussed above. Data units that may be generated and transmitted as discussed above are described in additional detail below.

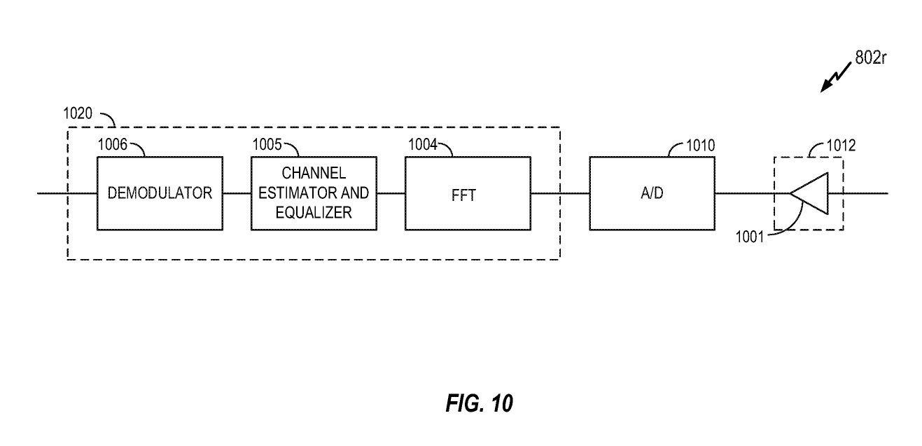

FIG. 10 illustrates various components that may be utilized in the apparatus 802 of FIG. 8 to receive wireless communication. The components illustrated in FIG. 10 may be used, for example, to receive OFDM communication. For example, the components illustrated in FIG. 10 may be used to receive data units transmitted by the components discussed above with respect to FIG. 9.

The receiver 1012 of apparatus 802r is configured to receive one or more packets or data units in a wireless signal. Data units that may be received and decoded or otherwise processed as discussed below.

In the aspect illustrated in FIG. 10, the receiver 1012 includes a receive amplifier 1001. The receive amplifier 1001 may be configured to amplify the wireless signal received by the receiver 1012. In some aspects, the receiver 1012 is configured to adjust the gain of the receive amplifier 1001 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 1001 comprises an LNA.

The apparatus 802r may comprise an analog to digital converter 1010 configured to convert the amplified wireless signal from the receiver 1012 into a digital representation thereof. Further to being amplified, the wireless signal may be processed before being converted by the analog to digital converter 1010, for example by being filtered or by being downconverted to an intermediate or baseband frequency. The analog to digital converter 1010 may be implemented in the processing system 804 (FIG. 8) or in another element of the apparatus 802r. In some aspects, the analog to digital converter 1010 is implemented in the transceiver 814 (FIG. 8) or in a data receive processor.

The apparatus 802r may further comprise a transform module 1004 configured to convert the representation of the wireless signal into a frequency spectrum. In FIG. 10, the transform module 1004 is illustrated as being implemented by a fast Fourier transform (FFT) module. In some aspects, the transform module may identify a symbol for each point that it uses. As described above with reference to FIG. 9, the transform module 1004 may be configured with a plurality of modes, and may use a different number of points to convert the signal in each mode. The number of points used by the transform module 1004 may be referred to as the size of the transform module 1004. In some aspects, the transform module 1004 may identify a symbol for each point that it uses.

The apparatus 802r may further comprise a channel estimator and equalizer 1005 configured to form an estimate of the channel over which the data unit is received, and to remove certain effects of the channel based on the channel estimate. For example, the channel estimator and equalizer 1005 may be configured to approximate a function of the channel, and the channel equalizer may be configured to apply an inverse of that function to the data in the frequency spectrum.

The apparatus 802r may further comprise a demodulator 1006 configured to demodulate the equalized data. For example, the demodulator 1006 may determine a plurality of bits from symbols output by the transform module 1004 and the channel estimator and equalizer 1005, for example by reversing a mapping of bits to a symbol in a constellation. The bits may be processed or evaluated by the processing system 804 (FIG. 8), or used to display or otherwise output information to the user interface 822 (FIG. 8). In this way, data and/or information may be decoded. In some aspects, the bits correspond to codewords. In one aspect, the demodulator 1006 comprises a QAM (quadrature amplitude modulation) demodulator, for example an 8-QAM demodulator or a 64-QAM demodulator. In other aspects, the demodulator 1006 comprises a binary phase-shift keying (BPSK) demodulator or a quadrature phase-shift keying (QPSK) demodulator.

In FIG. 10, the transform module 1004, the channel estimator and equalizer 1005, and the demodulator 1006 are illustrated as being implemented in the DSP 1020. In some aspects, however, one or more of the transform module 1004, the channel estimator and equalizer 1005, and the demodulator 1006 are implemented in the processing system 804 (FIG. 8) or in another element of the apparatus 802 (FIG. 8).

As discussed above, the wireless signal received at the receiver 812 comprises one or more data units. Using the functions or components described above, the data units or data symbols therein may be decoded evaluated or otherwise evaluated or processed. For example, the processing system 804 (FIG. 8) and/or the DSP 1020 may be used to decode data symbols in the data units using the transform module 1004, the channel estimator and equalizer 1005, and the demodulator 1006.

Data units exchanged by the AP 704 and the STA 706 may include control information or data, as discussed above. At the physical (PHY) layer, these data units may be referred to as physical layer protocol data units (PPDUs). In some aspects, a PPDU may be referred to as a packet or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

The apparatus 802t shown in FIG. 9 is an example of a single transmit chain used for transmitting via an antenna. The apparatus 802r shown in FIG. 10 is an example of a single receive chain used for receiving via an antenna. In some implementations, the apparatus 802t or 802r may implement a portion of a MIMO system using multiple antennas to simultaneously transmit data.

The wireless communication system 700 may employ methods to allow efficient access of the wireless medium based on unpredictable data transmissions while avoiding collisions. As such, in accordance with various aspects, the wireless communication system 700 performs carrier sense multiple access/collision avoidance (CSMA/CA) that may be referred to as the Distributed Coordination Function (DCF). More generally, an apparatus 802 having data for transmission senses the wireless medium to determine if the channel is already occupied. If the apparatus 802 senses the channel is idle, then the apparatus 802 transmits prepared data. Otherwise, the apparatus 802 may defer for some period before determining again whether or not the wireless medium is free for transmission. A method for performing CSMA may employ various gaps between consecutive transmissions to avoid collisions. In an aspect, transmissions may be referred to as frames and a gap between frames is referred to as an Interframe Spacing (IFS). Frames may be any one of user data, control frames, management frames, and the like.

IFS time durations may vary depending on the type of time gap provided. Some examples of IFS include a Short Interframe Spacing (SIFS), a Point Interframe Spacing (PIFS), and a DCF Interframe Spacing (DIFS) where SIFS is shorter than PIFS, which is shorter than DIFS. Transmissions following a shorter time duration will have a higher priority than one that must wait longer before attempting to access the channel.

A wireless apparatus may include various components that perform functions based on signals that are transmitted by or received at the wireless apparatus. For example, in some implementations a wireless apparatus comprises a user interface configured to output an indication based on a received signal as taught herein.

A wireless apparatus as taught herein may communicate via one or more wireless communication links that are based on or otherwise support any suitable wireless communication technology. For example, in some aspects a wireless apparatus may associate with a network such as a local area network (e.g., a Wi-Fi network) or a wide area network. To this end, a wireless apparatus may support or otherwise use one or more of a variety of wireless communication technologies, protocols, or standards such as, for example, Wi-Fi, WiMAX, CDMA, TDMA, OFDM, and OFDMA. Also, a wireless apparatus may support or otherwise use one or more of a variety of corresponding modulation or multiplexing schemes. A wireless apparatus may thus include appropriate components (e.g., air interfaces) to establish and communicate via one or more wireless communication links using the above or other wireless communication technologies. For example, a device may comprise a wireless transceiver with associated transmitter and receiver components that may include various components (e.g., signal generators and signal processors) that facilitate communication over a wireless medium.

The teachings herein may be incorporated into (e.g., implemented within or performed by) a variety of apparatuses (e.g., nodes). In some aspects, an apparatus (e.g., a wireless apparatus) implemented in accordance with the teachings herein may comprise an access point, a relay, or an access terminal.

An access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

A relay may comprise, be implemented as, or known as a relay node, a relay device, a relay station, a relay apparatus, or some other similar terminology. As discussed above, in some aspects, a relay may comprise some access terminal functionality and some access point functionality.

In some aspects, a wireless apparatus comprises an access device (e.g., an access point) for a communication system. Such an access device provides, for example, connectivity to another network (e.g., a wide area network such as the Internet or a cellular network) via a wired or wireless communication link. Accordingly, the access device enables another device (e.g., a wireless station) to access the other network or some other functionality. In addition, it should be appreciated that one or both of the devices may be portable or, in some cases, relatively non-portable. Also, it should be appreciated that a wireless apparatus also may be capable of transmitting and/or receiving information in a non-wireless manner (e.g., via a wired connection) via an appropriate communication interface.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3^{rd} Generation Partnership Project” (3GPP), while cdma2000 is described in documents from an organization named “3^{rd} Generation Partnership Project 2” (3GPP2). Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1×RTT, 1×EV-DO Re10, RevA, RevB) technology and other technologies.

### Example Communication Device

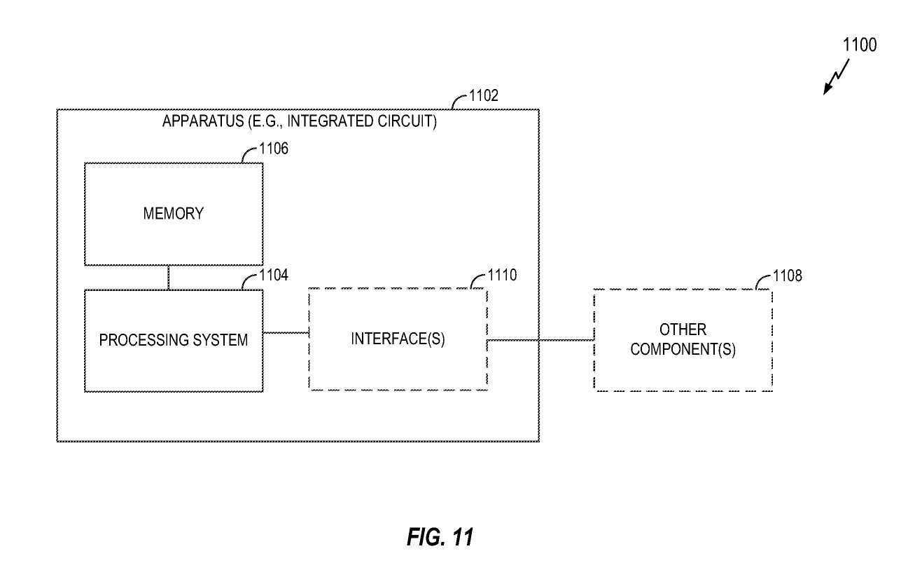

FIG. 11 illustrates an example apparatus 1100 (e.g., a BS, a STA, an AP, an AT, or some other type of wireless communication node) according to certain aspects of the disclosure. The apparatus 1100 includes an apparatus 1102 (e.g., an integrated circuit) and, optionally, at least one other component 1108. In some aspects, the apparatus 1102 may be configured to operate in a wireless communication node (e.g., an AP or an AT) and to perform one or more of the operations described herein. For convenience, a wireless communication node may be referred to herein as a wireless node. The apparatus 1102 includes a processing system 1104, and a memory 1106 coupled to the processing system 1104. Example implementations of the processing system 1104 are provided herein. In some aspects, the processing system 1104 and the memory 1106 of FIG. 11 may correspond to the processing system 804 and the memory component 806 of FIG. 8.

The processing system 1104 is generally adapted for processing, including the execution of such programming stored on the memory 1106. For example, the memory 1106 may store instructions that, when executed by the processing system 1104, cause the processing system 1104 to perform one or more of the operations described herein. As used herein, the terms “programming” or “instructions” or “code” shall be construed broadly to include without limitation instruction sets, instructions, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some implementations, the apparatus 1102 communicates with at least one other component (i.e., a component 1108 external to the apparatus 1102) of the apparatus 1100. To this end, in some implementations, the apparatus 1102 may at least one interface 1110 (e.g., a send/receive interface) coupled to the processing system 1104 for outputting and/or obtaining (e.g., sending and/or receiving) information (e.g., received information, generated information, decoded information, messages, etc.) between the processing system 1104 and the other component 1108. In some implementations, the interface 1110 may include an interface bus, bus drivers, bus receivers, other suitable circuitry, or a combination thereof. In some implementations, the interface 1110 may include radio frequency (RF) circuitry (e.g., an RF transmitter and/or an RF receiver). In some implementations, the interface 1110 may be configured to interface the apparatus 1102 to one or more other components of the apparatus 1100 (other components not shown in FIG. 11). For example, the interface 1110 may be configured to interface the processing system 1104 to a radio frequency (RF) front end (e.g., an RF transmitter and/or an RF receiver).

The apparatus 1102 may communicate with other apparatuses in various ways. In cases where the apparatus 1102 include an RF transceiver (not shown in FIG. 11), the apparatus may transmit and receive information (e.g. a frame, a message, bits, etc.) via RF signaling. In some cases, rather than transmitting information via RF signaling, the apparatus 1102 may have an interface to provide (e.g., output, send, transmit, etc.) information for RF transmission. For example, the processing system 1104 may output information, via a bus interface, to an RF front end for RF transmission. Similarly, rather than receiving information via RF signaling, the apparatus 1102 may have an interface to obtain information that is received by another apparatus. For example, the processing system 1104 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

### First Example Process

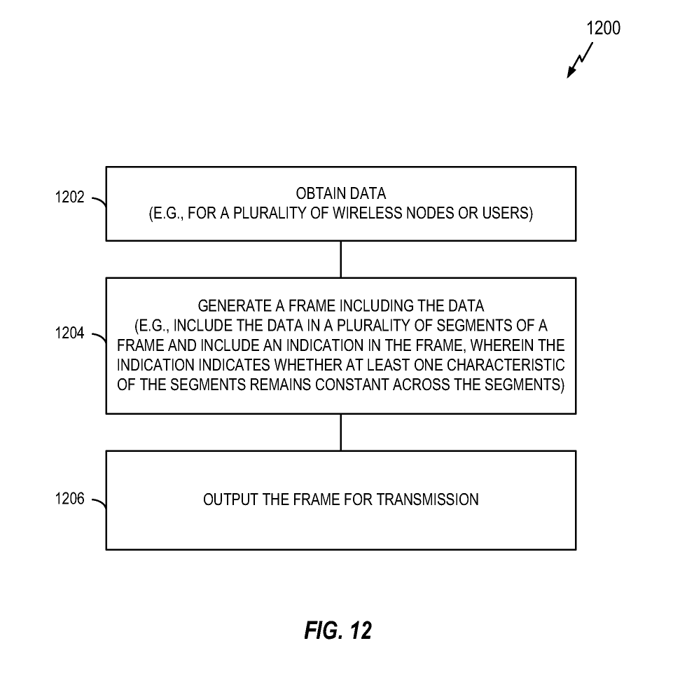

FIG. 12 illustrates a process 1200 for communication in accordance with some aspects of the disclosure. The process 1200 may take place within a processing system (e.g., the processing system 1104 of FIG. 11), which may be located in a BS, a STA, an AP, an AT, or some other suitable apparatus. Of course, in various aspects within the scope of the disclosure, the process 1200 may be implemented by any suitable apparatus capable of supporting communication-related operations.

At block 1202, an apparatus (e.g., a chip or a receiver of a receiving wireless node) obtains data. In some aspects, the data may be for a plurality of users and/or wireless nodes. In some aspects, obtaining data may involve a chip acquiring the data from another device (e.g., from a receiver that received the data). In some aspects, obtaining data may involve a wireless node or receiver receiving the data.

At block 1204, the apparatus generates a frame including the data obtained at block 1202. In some aspects, the generation of the frame may involve including the data from block 1202 in a plurality of segments of the frame and including an indication in the frame. In some aspects, the indication may indicate whether at least one characteristic of the segments remains constant across the segments. In some aspects, at least one of the segments may include information for at least two wireless nodes. In some aspects, the frame may be an IEEE 802.11ax frame. In some aspects, the frame may be a Physical Layer Convergence Protocol (PLCP) Protocol Data Unit.

The at least one characteristic may take various forms in different implementations. In some aspects, the at least one characteristic may include a segment length. In some aspects, the at least one characteristic may include a resource allocation. In some aspects, the at least one characteristic may include a frequency of occurrence of channel estimation information for the segments. In some aspects, the at least one characteristic may include a frequency of occurrence of a gain setting field for the segments. In some aspects, the at least one characteristic may include any combination of the above.

The frame may be generated in various ways in different implementations. In some aspects, the generation of the frame may involve including, in a first signaling field of the frame, and indication of which wireless nodes need to monitor subsequent signaling fields of the frame. In some aspects, the generation of the frame may involve including, in the frame, a plurality of signaling fields for each segment of the frame.

In some aspects, the generation of the frame may involve including another indication in the frame, wherein the other indication indicates whether the frame includes the plurality of segments. In some aspects, the other indication may be a Doppler bit.

In some aspects, the generation of the frame may involve including information for all of the segments in a first signaling field of the frame. In some aspects, the information may include: lengths of the segments, resource allocations for the segments, or any combination thereof.

In some aspects, the generation of the frame may involve including, preceding each segment, information for the segment. In some aspects, the information may include: a length of a particular segment, a resource allocation for a particular segment, or any combination thereof.

In some aspects, the generation of the frame may involve specifying a purpose for a signaling field of the frame depending on a value of the indication. In some aspects, the signaling field may be an IEEE 802.11ax HE-SIG-B field.

At block 1206, the apparatus outputs the frame for transmission. In some aspects, outputting the frame for transmission may involve a chip outputting the frame for transmission by another device (e.g., by a transmitter). In some aspects, outputting the frame for transmission may involve a wireless node or a transmitter transmitting the frame.

In some aspects, a process in accordance with the teachings herein may include any combination of the operations of the process 1200.

### Second Example Process

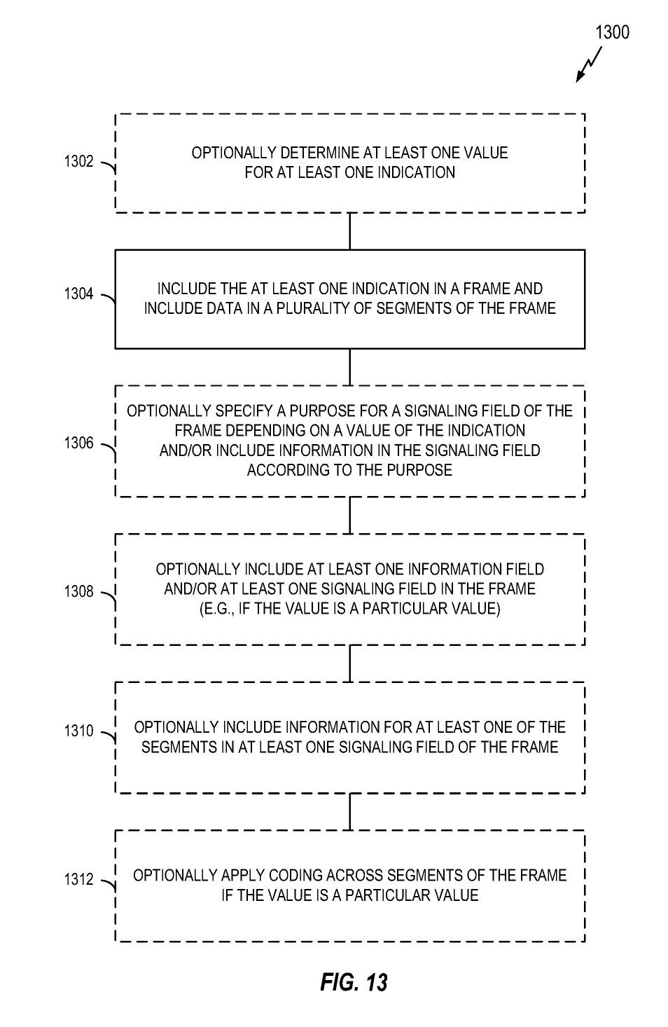

FIG. 13 illustrates a process 1300 for communication in accordance with some aspects of the disclosure. One or more aspects of the process 1300 may be used in conjunction with (e.g., in addition to or as part of) the process 1200 of FIG. 12. The process 1300 may take place within a processing system (e.g., the processing system 1104 of FIG. 11), which may be located in a BS, a STA, an AP, an AT, or some other suitable apparatus. Of course, in various aspects within the scope of the disclosure, the process 1300 may be implemented by any suitable apparatus capable of supporting communication-related operations.

At optional block 1302, an apparatus may determine at least one value for at least one indication. For example, the generation of the frame at block 1204 of FIG. 12 may involve determining a value for an indication (e.g., assigning a value of ON or OFF to the indication). In some aspects, one such indication may indicate whether at least one characteristic of the segments of the frame remains constant across the segments. In some aspects, one such indication may indicate whether the frame includes the plurality of segments. In some aspects, one such indication may indicate which wireless nodes need to monitor subsequent signaling fields of the frame. In some aspects, one such indication may be a multi-segment bit. In some aspects, one such indication may be a Doppler bit.

At block 1304, the apparatus includes the at least one indication in a frame and includes data in a plurality of segments of the frame. For example, the generation of the frame at block 1204 of FIG. 12 may involve setting a particular field of the frame to a value determined at block 1302.

At optional block 1306, the apparatus may specify a purpose for a signaling field of the frame depending on a value of the indication and/or include information in a signaling field of the frame according to a specified purpose (e.g., include information in the signaling field according to the purpose). In some aspects, the signaling field may be an IEEE 802.11ax HE-SIG-B field (e.g., a common field). For example, the HE-SIG-B common field may be purposed for conveying a resource unit allocation if the multi-segment bit (e.g., the Doppler bit) is OFF, and purposed for conveying other information if the multi-segment bit is ON.

At optional block 1308, the apparatus may include an information field and/or a signaling field in the frame if the value determined at block 1302 is a particular value (e.g., indicating a multi-segment transmission). For example, the generation of the frame at block 1204 of FIG. 12 may involve including, in the frame, a plurality of signaling fields for each segment of the frame.

An information field may take various forms in different implementations. In some aspects, the information field may indicate a length of a signaling field for a segment in the frame (e.g., for at least one of the segments of the frame), a length of a payload for a segment in the frame (e.g., for at least one of the segments of the frame), a quantity of signaling segments in the frame, whether there are additional signaling segments in the frame, or any combination thereof. In some aspects, the signaling segments may include IEEE 802.11ax HE-SIG-B fields. In some aspects, the information field may indicate that the frame is for a high mobility scenario. In some aspects, the information field may indicate an occurrence frequency for midambles within the frame. In some aspects, the midambles may include channel estimation information, gain settings, or any combination thereof.

At optional block 1310, the apparatus may include information for at least one of the segments in at least one signaling field of the frame. For example, the generation of the frame at block 1204 of FIG. 12 may involve including information for all of the segments in a first signaling field of the frame. In this case, the information may include lengths of the segments, resource allocations for the segments, or any combination thereof. As another example, the generation of the frame at block 1204 of FIG. 12 may involve including, preceding each particular segment of the frame, information for the particular segment. In this case, the information for the particular segment may include a length of the particular segment, a resource allocation for the particular segment, or any combination thereof.

At optional block 1312, the apparatus may apply coding across the segments if the value determined at block 1302 is a particular value (e.g., indicating a multi-segment transmission).

In some aspects, a process in accordance with the teachings herein may include any combination of the operations of the process 1300.

### Example Apparatus

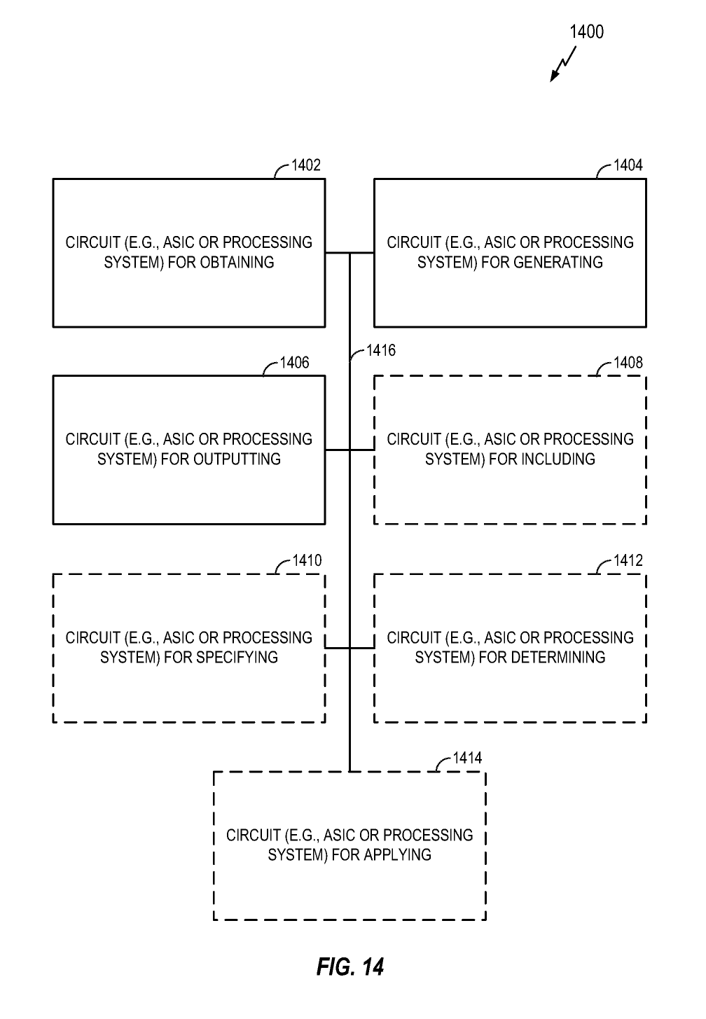

The components described herein may be implemented in a variety of ways. Referring to FIG. 14, an apparatus 1400 is represented as a series of interrelated functional blocks that represent functions implemented by, for example, one or more integrated circuits (e.g., an ASIC) or implemented in some other manner as taught herein. As discussed herein, an integrated circuit may include a processor, software, other components, or some combination thereof.

The apparatus 1400 includes one or more components (modules) that may perform one or more of the functions described herein with regard to various figures. For example, a circuit (e.g., an ASIC or processing system) for obtaining 1402, e.g., a means for obtaining, may correspond to, for example, an interface (e.g., a bus interface, a send/receive interface, or some other type of signal interface), a communication device, a transceiver, a receiver, or some other similar component as discussed herein. A circuit (e.g., an ASIC or processing system) for generating 1404, e.g., a means for generating, may correspond to, for example, a processing system as discussed herein. A circuit (e.g., an ASIC or processing system) for outputting 1406, e.g., a means for outputting, may correspond to, for example, an interface (e.g., a bus interface, a send/receive interface, or some other type of signal interface), a communication device, a transceiver, a transmitter, or some other similar component as discussed herein. An optional circuit (e.g., an ASIC or processing system) for including 1408, e.g., a means for including, may correspond to, for example, a processing system as discussed herein. An optional circuit (e.g., an ASIC or processing system) for specifying 1410, e.g., a means for specifying, may correspond to, for example, a processing system as discussed herein. An optional circuit (e.g., an ASIC or processing system) for determining 1412, e.g., a means for determining, may correspond to, for example, a processing system as discussed herein. An optional circuit (e.g., an ASIC) for applying 1414, e.g., a means for applying, may correspond to, for example, a processing system as discussed herein. Two or more of the modules of FIG. 14 may communicate with each other or some other component via a signaling bus 14146. In various implementations, the processing system 804 of FIG. 8 and/or the processing system 1104 of FIG. 11 may include one or more of the circuit for obtaining 1402, the circuit for generating 1404, the circuit for outputting 1406, the circuit for including 1408, the circuit for specifying 1410, the circuit for determining 1412, or the circuit for applying 1414.

As noted above, in some aspects these modules may be implemented via appropriate processor components. These processor components may in some aspects be implemented, at least in part, using structure as taught herein. In some aspects, a processor may be configured to implement a portion or all of the functionality of one or more of these modules. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. In some aspects one or more of any components represented by dashed boxes are optional.

The apparatus 1400 include one or more integrated circuits in some implementations. For example, in some aspects a single integrated circuit implements the functionality of one or more of the illustrated components, while in other aspects more than one integrated circuit implements the functionality of one or more of the illustrated components. As one specific example, the apparatus 1400 may include a single device (e.g., with the circuit for obtaining 1402, the circuit for generating 1404, the circuit for outputting 1406, the circuit for including 1408, the circuit for specifying 1410, the circuit for determining 1412, and the circuit for applying 1414 comprising different sections of an ASIC). As another specific example, the apparatus 1400 may include several devices (e.g., with the circuit for obtaining 1402 and the circuit for outputting 1406 implemented in one ASIC, and the circuit for generating 1404, the circuit for including 1408, the circuit for specifying 1410, the circuit for determining 1412, and the circuit for applying 1414 implemented in another ASIC).

In addition, the components and functions represented by FIG. 14 as well as other components and functions described herein, may be implemented using any suitable means. Such means are implemented, at least in part, using corresponding structure as taught herein. For example, the components described above in conjunction with the “ASIC for” components of FIG. 14 correspond to similarly designated “means for” functionality. Thus, one or more of such means is implemented using one or more of processor components, integrated circuits, or other suitable structure as taught herein in some implementations.

The various operations of methods described herein may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar functionality and/or numbering. For example, the blocks of the processes 1200 and 1300 illustrated in FIGS. 12 and 13 may correspond at least in some aspects, to corresponding blocks of the apparatus 1400 illustrated in FIG. 14.

### Example Programming

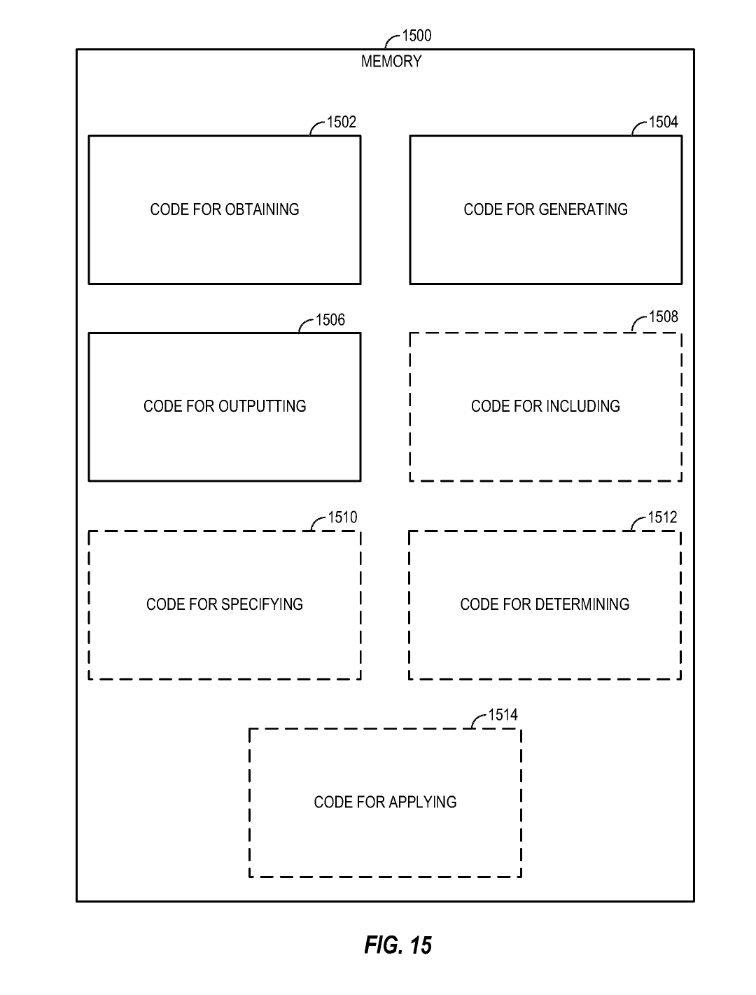

Referring to FIG. 15, programming stored by the memory 1500 (e.g. a storage medium, a memory device, etc.), when executed by a processing system (e.g., the processing system 1104 of FIG. 11), causes the processing system to perform one or more of the various functions and/or process operations described herein. For example, the programming may cause the processing system 1104 to perform the various functions, steps, and/or processes described herein with respect to FIGS. 1, 5, 12, and 13 in various implementations. As shown in FIG. 15, the memory 1500 may include one or more of code for obtaining 1502, code for generating 1504, code for outputting 1506, optional code for including 1508, optional code for specifying 1510, optional code for determining 1512, or optional code for applying 1514. In some aspects, one of more of the code for obtaining 1502, the code for generating 1504, the code for outputting 1506, the code for including 1508, the code for specifying 1510, the code for determining 1512, or the code for applying code 1514 may be executed or otherwise used to provide the functionality described herein for the circuit for obtaining 1402, the circuit for generating 1404, the circuit for outputting 1406, the circuit for including 1408, the circuit for specifying 1410, the circuit for determining 1412, or the circuit for applying 1414. In some aspects, the memory 1500 of FIG. 15 may correspond to the memory 1106 of FIG. 11.

### Additional Aspects

The examples set forth herein are provided to illustrate certain concepts of the disclosure. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

As those skilled in the art will readily appreciate, various aspects described throughout this disclosure may be extended to any suitable telecommunication system, network architecture, and communication standard. By way of example, various aspects may be applied to wide area networks, peer-to-peer network, local area network, other suitable systems, or any combination thereof, including those described by yet-to-be defined standards.

Many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

One or more of the components, steps, features and/or functions illustrated in above may be rearranged and/or combined into a single component, step, feature or function or embodied in several components, steps, or functions. Additional elements, components, steps, and/or functions may also be added without departing from novel features disclosed herein. The apparatus, devices, and/or components illustrated above may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example of a storage medium is coupled to the processor such that the processor can read information from, and write information to, the storage medium. In the alternative, the storage medium may be integral to the processor.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may comprise one or more elements. In addition, terminology of the form “at least one of a, b, or c” or “a, b, or c or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated.

1. An apparatus for communication, comprising:
an interface configured to obtain data; and
a processing system configured to generate a frame including the data, wherein the generation of the frame comprises:
including the data in a plurality of segments of the frame, and
including an indication in the frame, wherein the indication indicates whether at least one characteristic of the segments remains constant across the segments,
wherein the interface is further configured to output the frame for transmission.

2. The apparatus of claim 1, wherein the at least one characteristic comprises a segment length.

3. The apparatus of claim 1, wherein the at least one characteristic comprises a resource allocation.

4. The apparatus of claim 1, wherein the at least one characteristic comprises a frequency of occurrence of channel estimation information for the segments.

5. The apparatus of claim 1, wherein the at least one characteristic comprises a frequency of occurrence of a gain setting field for the segments.

6. The apparatus of claim 1, wherein the generation of the frame further comprises including another indication in the frame, wherein the other indication indicates whether the frame includes the plurality of segments.

7. The apparatus of claim 6, wherein the other indication is a Doppler bit.

8. The apparatus of claim 1, wherein the generation of the frame further comprises including information for all of the segments in a first signaling field of the frame.

9. The apparatus of claim 8, wherein the information comprises: lengths of the segments, resource allocations for the segments, or any combination thereof.

10. The apparatus of claim 1, wherein the generation of the frame further comprises including, preceding each particular segment of the frame, information for the particular segment.

11. The apparatus of claim 10, wherein the information for the particular segment comprises: a length of the particular segment, a resource allocation for the particular segment, or any combination thereof.

12. The apparatus of claim 1, wherein the generation of the frame further comprises including, in a first signaling field of the frame, an indication of which wireless nodes need to monitor subsequent signaling fields of the frame.

13. The apparatus of claim 1, wherein the generation of the frame further comprises:
specifying a purpose for a signaling field of the frame depending on a value of the indication.

14. The apparatus of claim 13, wherein the generation of the frame further comprises:
including information in the signaling field according to the purpose.

15-17. (canceled)

18. The apparatus of claim 1, wherein the generation of the frame further comprises:
determining a value for the indication; and
including an information field in the frame if the value is a particular value.

19. The apparatus of claim 18, wherein the information field indicates a length of a signaling field for at least one of the segments of the frame, a length of a payload for at least one of the segments of the frame, a quantity of signaling segments in the frame, whether there are additional signaling segments in the frame, or any combination thereof.

20-21. (canceled)

22. The apparatus of claim 18, wherein the information field indicates an occurrence frequency for midambles within the frame.

23. (canceled)

24. The apparatus of claim 1, wherein the generation of the frame further comprises:
determining a value for the indication; and
applying coding across the segments if the value is a particular value.

25-27. (canceled)

28. A method of communication, comprising:
obtaining data;
generating a frame including the data, wherein the generation of the frame comprises:
including the data in a plurality of segments of the frame, and
including an indication in the frame, wherein the indication indicates whether at least one characteristic of the segments remains constant across the segments; and
outputting the frame for transmission.

29-81. (canceled)

82. A wireless node, comprising:
a receiver configured to receive data;
a processing system configured to generate a frame including the data, wherein the generation of the frame comprises:
including the data in a plurality of segments of the frame, and
including an indication in the frame, wherein the indication indicates whether at least one characteristic of the segments remains constant across the segments; and
a transmitter configured to transmit the frame.

83. (canceled)
